(19) United States
(12) Patent Application Publication
(10) Pub. No.: US 2011/0071994 A1
(43) Pub. Date: Mar. 24, 2011

(54) METHOD AND SYSTEM TO SECURELY STORE DATA

(75) Inventor: Majid N. TABRIZI, Herndon, VA (US)

(73) Assignee: APPSIMPLE, LTD, Nassau (BS)

(21) Appl. No.: 12/749,009

(22) Filed: Mar. 29, 2010

Related U.S. Application Data
(60) Provisional application No. 61/244,541, filed on Sep. 22, 2009.

(51) Int. Cl. G06F 17/30

(52) U.S. Cl. 707/705; 707/802; 707/E17.044; 707/E17.005

(57) ABSTRACT

Secure management of data is provided by selectively accessing multiple databases. The method and system includes substituting data of a predetermined field in a record with a key generated to correspond to the data, storing the record with the key in the predetermined field in a first database and associating the key with the data and storing the association in a second database.

### CROSS-REFERENCE TO RELATED APPLICATION

This application is related to and claims priority to U.S. Provisional Application Ser. No. 61/244,541, filed Sep. 22, 2009, inventor Majid N. Tabrizi, titled USING MULTIPLE DATABASES TO SECURELY STORE DATA, in the United States Patent and Trademark Office, the disclosure of which is incorporated herein by reference.

### BACKGROUND

1. Field

The embodiments discussed herein are directed to managing data and, more particularly, to securely storing data and controlling access to the data using multiple databases.

2. Description of the Related Art

Systems and procedures that protect data from unauthorized access continue to be increasingly vital to business operations and individuals. The need for solutions to ensure secure management of data is further increased as technology that enable ease of access to stored data continue to be developed and portability and use of storage devices such as removable media, laptop, or other plug-and-play storage device continue to become widespread.

Existing storage solutions including those equipped with various security protocols typically store data in a single location. In such a case, data may be stored in a single storage drive or a cluster of data servers working as one. Since data servers work as one even when separated by physical locations, no level of security exists that provides protection against all threats. While encryption provides a vital tool, a database is exposed when the encryption is compromised. Other solutions also suffer from the same drawback since the data is stored and managed in database(s) acting as one.

In addition, storage solutions that operate as one generally require that a user be given a password or other code(s) for accessing protected data. In this situation, security of the data may be compromised as a result of a stolen password or an internal hack job. Further, when data is stored in databases working as one, generally the entire content of the databases is at risk of exposure.

There has been a growing trend towards a centralized model of managing and accessing data due to services such as SaaS (Software As A Service), cloud computing, and similar other services. As a result, there is a need to protect data in this type of environment.

In light of the above and other problems in typical data storage and management solutions, there is a need for securely storage and access related to data.

### SUMMARY

It is an aspect of the embodiments discussed herein to provide a method and system implementing secure management of data including substituting data of a predetermined field in a record with a key generated to correspond to the data, storing the record with the key in the predetermined field in a first database and associating the key with the data and storing the association in a second database.

The above aspects can be attained by a system that includes a first database storing keys replacing corresponding data of predetermined fields in records, a second database storing the keys in association with the corresponding data and a computer providing the records by retrieving the predetermined fields including keys from the first database, and obtaining the corresponding data associated with the keys from the second database.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1A illustrates a system configured to perform management of data.

FIG. 1B illustrates a system for maintaining selective communication to securely manage data.

FIG. 2 illustrates a flowchart for managing data of a predetermined field in a record.

FIG. 3 illustrates a system for managing data of fields of a record that are replaced and stored with a corresponding key.

FIG. 4A illustrates content of a main database.

FIG. 4B illustrates content of a secondary database.

FIG. 5A illustrates content of an original data in a database.

FIG. 5B illustrates content resulting from modification to an original data of a database.

FIG. 5C illustrates a record created in accordance with modification to an original data of a database.

FIG. 6 illustrates a flow for populating an application with data and providing a record responsive to a request.

FIG. 7 illustrates a flowchart for adding a new record.

FIG. 8 illustrates a flowchart for retrieving a record.

FIG. 9 illustrates a flowchart for editing a record.

FIG. 10 illustrates a schema for providing a layer of security.

FIG. 11 illustrates a security mechanism triggering an event when data is compromised.

### DETAILED DESCRIPTION OF THE EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

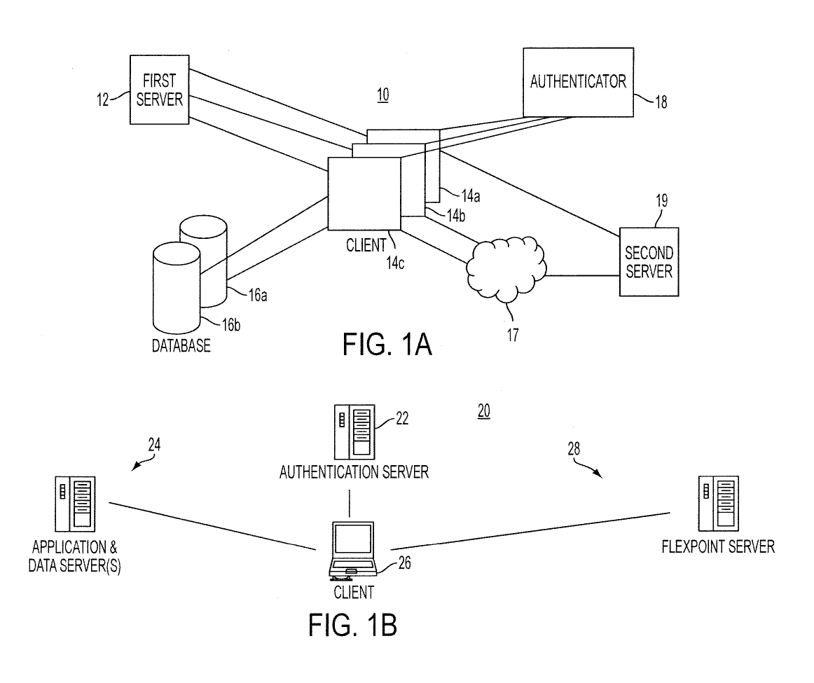

A solution for secure management of data is provided by system 10 illustrated in FIG. 1A. As shown in FIG. 1A, the system 10 includes a first server 12, an authenticator 18, clients 14a, 14b, 14c, databases 16a, 16b and a second server 19. The first server 12 stores a predetermined field of a record with a corresponding key. The second server 19 stores original data of the predetermined field in association with the corresponding key. The authentication server 18 processes information to verify identity of users and route the information as needed.

The clients 14a, 14b, 14c are not limited to the general description in FIG. 1A. For example, the clients 14a, 14b, 14c may be any computer, a device, a specialized terminal, a Netbook, portable device such as a personal digital assistant (PDA) or a smart phone, or any source from which data may be accessed. Similarly, the first server 12, the authentication server 18 and the second server 19 are not limited to the general description in FIG. 1A. While specific components are used to describe FIG. 1A, the system 10 of the present invention is not limited to nay particular type or number.

Referring to FIG. 1A, data between the clients 14b and 14c and the second server 19 is exchanged via a network 17. While only the network 17 is illustrated in FIG. 1A, the system 10 is not limited to the general description in FIG. 1A and may include one or more networks such as local area networks, the Internet, wireless network, etc.

The system 10 includes database 16a and 16b which are accessible by the client 14c. For ease of explanation, the database 16a and 16b are connected with the client 14c but the system 10 may be configured such that the databases 16a and 16b and accessible by all of the clients 14a, 14b, 14c. The databases 16a, 16b may be of any type of storage technology including but not limited to a Network Attached Storage (NAS), a Storage Area Network (SAN), etc. and data stored therein may be organized using any conventional or proprietary database software.

The databases 16a and 16b respectively store data of records having predetermined fields substituted with corresponding keys and the data with corresponding keys. The databases 16a and 16b, the first server 12 and the second server 19 are configured to maintain data of a predetermined field, a key corresponding to the predetermined field and data originally contained in the predetermined field. The first server 12 and the second server 19 may be integrated with one or more storage devices and/or may be communicatively coupled with an external storage. In an embodiment, the database 16a stores a record with a key in a predetermined field while the second server 19 stores the key in association with data of the predetermined field.

A request from the clients 14a, 14b, 14c is verified using various types of authentication mechanisms including but not limited to encryption, passwords, biometrics, or any other access control. However, the present invention is not limited to the general description of authentication mechanisms.

The system 10 removes a relationship or link between data in a predetermined field of a record and the field without compromising or losing data integrity. This serves to enhance security because even in a situation of unauthorized access to data, one would not be able to ascertain the meaning of data. As shown in FIG. 1A and explained in detail below, an unauthorized access to the first server 12 would only result in access to data substituted by randomly generated keys in fields of the records. On the other hand, the second server 19 only contains the data in correspondence with the keys.

The first server 12, the second server 19 and the databases 16a, 16b may be provided at different physical locations, or may be provided at a single data center having separated part of a hard disk dedicated to particular operations without requiring the separated part to work as one. Location of the first server 12, the second server 19 and the databases 16a, 16b may be changed to fit various environments.

FIG. 1B shows a system 20 for maintaining selective communication to securely manage data. As shown in FIG. 1B, a client 26 communicates with each of an authentication server 22, application and data server 24 and a server 28. As shown in FIG. 1B, there is no direct communication between the authentication server 22, the application and data server 24 and the server 28, while each communicate independently with the client 26.

Referring to FIG. 1B, communication is performed in a disconnected manner where the authentication server 22, the application and data server 24 and the server 28 are not required to communicate with each other, or even be aware of each other's existence to mange and process request for the data. This enables the client 26 to play an essential role by serving as a bridge between the application and data server 24 and the server 28. The implementation of the system 20 as shown in FIG. 1B provides security since there is no complete record that is accessible at any particular time.

In an embodiment, operations of the first server 12 illustrated in FIG. 1A may be implemented using the application/data server 24 in FIG. 1B while operation of the second database 19 of FIG. 1A may be implemented using the server 28. While references are made to specific types of servers in FIGS. 1A and 1B, the present invention is not limited to any particular type of server and any server may be used that enables data exchange and execution of processes including data for supporting application(s) and/or service(s).

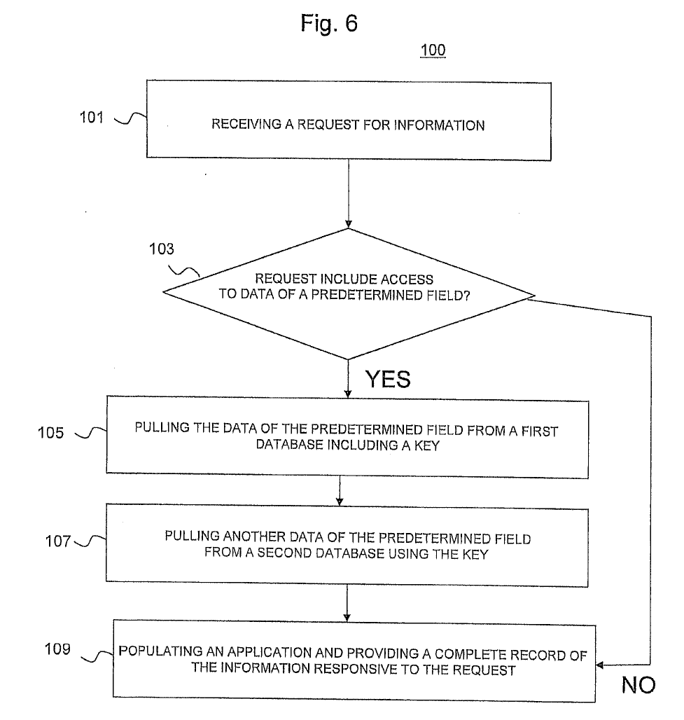

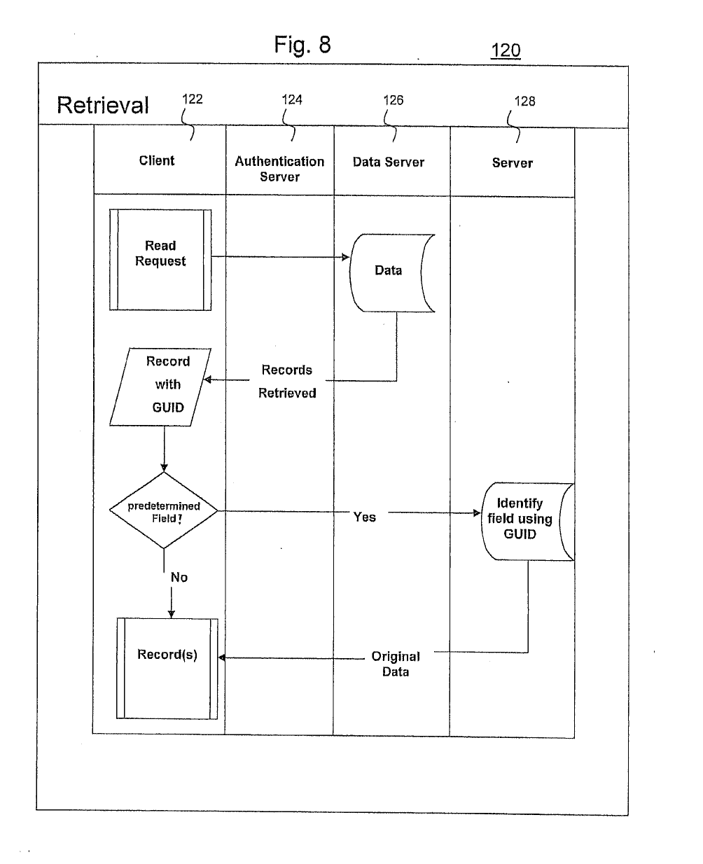

Similar to the clients 14a, 14b, 14c shown in FIG. 1A, the client 26 is not limited to any particular type of computer. The client 26 includes an interface that enables data to be downloaded such that when a program residing thereon is re-launched, a local copy is loaded when determining no new version of the program exists on the system 20. The client 26 serves as a remote SaaS model or smart client model where when a login is authorized, the system 20 starts building data based on communication between an application of the client 26 and the data server 24 and the server 28. An operation of data retrieval is described in detail in at least FIG. 6 and FIG. 8.

The system 20 enables indirect communication between components of the system 20 via an application software designed to bring together operation(s) of the authentication server 22, the application and data server 24 and the server 28, at the client 26. The application residing on the client 26 performs operations including but not limited to receiving a request, identifying a record requested, exchanging information to authenticate a user, determining whether the request should be sent to one or more of the authentication server 22, the application and data server 24 and the server 28. For example, after verifying that a user is authenticated, the application on the client 26 determines a record related to contact information is requested and whether the record includes a predetermined field, and sends corresponding signals to communicate all fields with the application and data server 24 and the predetermined field to the server 28 based on the determination.

Determination of whether a request from the client 26 contains data of a predetermined field may be executed by an application residing on the client 26, the authentication server 22, or both. In an embodiment, an application of the client 26 determines whether data of a predetermined field is requested. Since the application is used during only the moment of use, using the application for such determination enables the system 20 to securely exchange data by causing exchange of data via one or more of the servers to occur as infrequently as possible.

Alternatively, the system 20 may cause a signal to be sent to the server 28 and the application and data server 24 each time a request is received from the client 26, or the system 20 may automatically anticipate and start building data of predetermined field(s), if any, when a user of the client 26 has been authenticated. For example, the client 26 may build a cache of anticipated items based on determination that items are frequently used and start building the data while the user is in the process of accessing the system 20.

Determination of whether to store data locally at client 26 for preloading may be made based on various conditions including optimization concerns. A system administrator or manager may indicate which data is to be stored in a cache and preloaded to the client 26 while a user is being authenticated. This consideration may be customized based on, for example, data that is being managed by the system 20. For example, the client 26 may identify a user, a position of the user within a company, work with which the user is associated, etc., and build applicable information in cache.

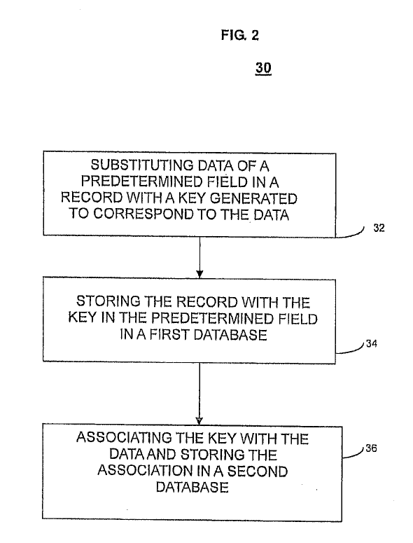

FIG. 2 illustrates process 30 for managing data of a predetermined field in a record. As shown in FIG. 2, the process 30 begins at operation 32, where data of a predetermined field in a record is substituted with a key generated to correspond to the data. For example, when a record contains a field for a name of a customer, the customer's name is replaced or substituted with a key or code randomly generated by the system 10 (FIG. 1A) or any other system. Similarly, when a record contains a field for a phone number, the phone number is substituted with a key or code corresponding to the phone number. For example, a key ‘xyz’ substitutes the customer name ‘John Smith’ in the customer name field and causes the data in the customer name field to essentially be translated to another data.

A system or an administrator may provide a key or code to be used for substituting data of a field in a record. In an embodiment, a key or code is randomly generated by a system to correspond to data of a predetermined field in a record. In another embodiment, a numbering scheme associated with an index of a data structure may be used for substituting data of a field. The key or code may be of any format and include but not limited to numbers, letters, etc., such as a globally unique identifier (GUID).

As shown in FIG. 2, from operation 32, the process 30 moves to operation 34, where the record with the key in the predetermined field is stored in a first database. Using the same example used in the operation 32, the field containing the customer name and the field with the phone number are stored with a corresponding key in a first database. For example, the key ‘xyz’ used to replace the customer name ‘John Smith’ in the customer name field is stored in the first server 12 of the system 10 (FIG. 1).

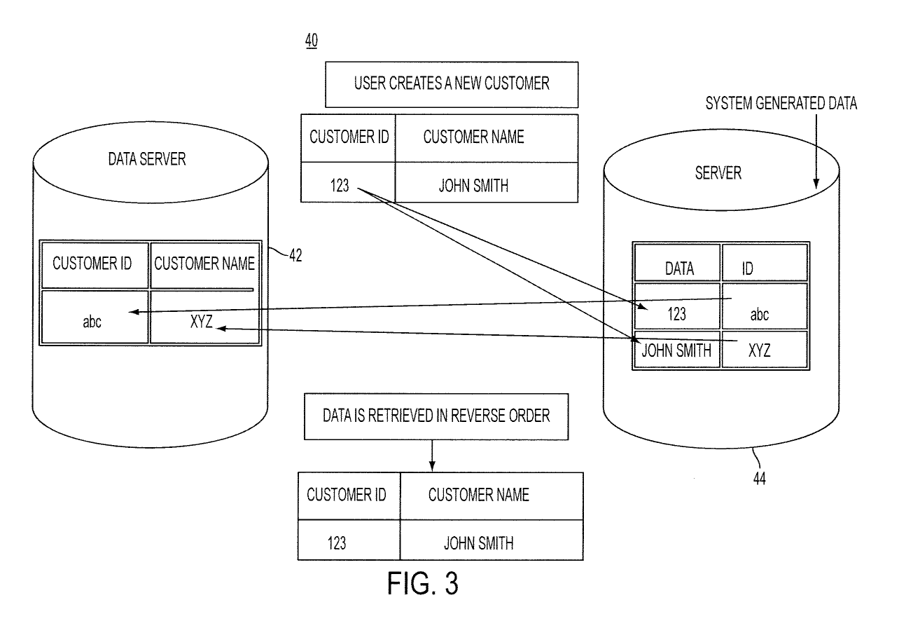

After operation 34, the process 30 moves to operation 36, where the key is associated with the data and stored in a second database. A key used to substitute data of a predetermined field is associated with the data and stored in a second database that is different from the first database. For example, the key ‘xyz’ is stored in the second server 19 (FIG. 1A) in association with data ‘John Smith.” Association of a key with corresponding data may be achieved in various ways including but not limited to setting a pointer to the data in a database that specifies location of the key. An operation of managing data of a predetermined field in a record is discussed in detail below including with respect to FIG. 3.

FIG. 3 illustrates a system 40 for managing data of fields of a record that are replaced and stored with a corresponding key. As shown in FIG. 3, the system 40 includes a data server 42 containing data of predetermined fields replaced or substituted with generated key and a server 44 storing the generated key in association with the data. When a user creates a new customer record, the new record may have a field for customer identification (ID) ‘123’ and a field for a customer name ‘John Smith”, both of which are designated as candidate data critical for data security. A field of any record may be created and identified as essential to security. Although FIG. 3 illustrates a new record being created by a user, the present invention is not limited thereto and a record may automatically be created by the system 10 (FIG. 1A). As shown in FIG. 3, the arrows represent respective substitution of the data in the server(s) when a new record is created.

When a new record is being built, it is possible to identify a candidate field containing data that needs to be protected or secured. A determination may be made based on judgment of an individual user (administrator), a guideline of an industry, a company/user need, etc. Using the system 10 (FIG. 1A), a flag may be set to a field to indicate the field as a candidate and the flag designation of the field may be adjusted to selectively set the protection status ON/OFF. For example, contact information of a record may include a field corresponding to each of a name, an address, a telephone number, a fax number, and a user may identify all fields with the exception of the fax number field as candidates for protection. Alternatively, the user may identify just a field of the telephone number as a candidate or all of the fields in the contact information record as candidates.

The determination for identifying a candidate field may be made based on various criteria including but not limited to identification of what part of the record needs to be protected/secured, ownership of the data, potential widespread accessibility of any part of the data, level of security requested or warranted, structure of data in a database, etc. Although few items are mentioned herein as basis of determination to select as a candidate field, the present invention is not limited to any one of items. For example, a field may be set as a candidate field for protection because access to data contained therein would lead to access to other data. For example, when access to a piece of data is obtained, it may be the case that determination of the remaining part of the data may be easily achieved because initial data already obtained links the remaining data.

As illustrated in FIG. 3, the record with the field customer ID containing ‘123’ is replaced with a key ‘abc’ and the field for the customer name containing ‘John Smith’ is substituted with a key ‘xyz.’ The data server 42 stores the customer ID field with the key ‘abc’ and the field for the customer name with the key ‘xyz’ while the server 44 stores the data ‘123’ and ‘John Smith’ in association with respective keys ‘abc’ and ‘xyz.’

When a predetermined field in the system 40 is flagged for substitution, a table is created in the server 44, according to an embodiment. The table serves as a dictionary that holds a list of predetermined fields from the data server 42. When a login request is received via an application residing on client 26 (FIG. 1A), for example, the application retrieves the dictionary (flags) and uses the dictionary to look for values corresponding to the predetermined fields. Thus, when a particular field is flagged by being listed in the dictionary, the application sends the value retrieved (the key) from the data server 42 to the server 44 and retrieves the corresponding value from the server 44 using the key. Similarly, the application may send the key from the first database 12 in FIG. 1A to the second database 19 and retrieve a corresponding value from the second database 19. In a situation the process fails for whatever reason, various events may be triggered including causing the application to display the key in place of the original data.

The system 40 enables any new field of a database to be added to the dictionary. Alternatively, status of an existing field may be changed by converting all records after adding the field to the dictionary. The flags identify a field to be replaced and a field that remains as ‘regular’ field and may be adjusted or customized including based on changing needs. While FIG. 3 illustrates a system 40 of substituting predetermined fields of a new record, the present invention may also be applied to existing data. A utility or tool is executed for taking the existing data, creating a table and replacing an original data and removing a link between any of fields and data contained therein.

When data of the new customer is requested in FIG. 3, the data is retrieved in a reverse order such that a complete record is displayed in response to a request. Meaning, an application retrieves a key corresponding to a predetermined field from the data server 42 and utilizes the key to retrieve data of the predetermined field from the server 44. A user presented with data stored in the system 40 is not required to have knowledge of which field designation of the content provided.

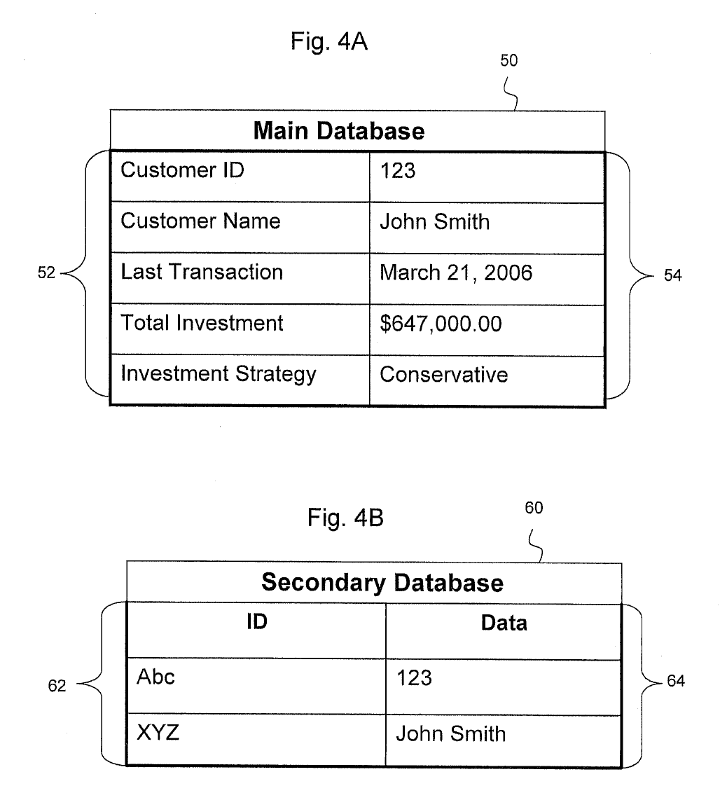

FIG. 4A illustrates content of a main database 50 including fields 52 and corresponding data 54. As shown in FIG. 4A, the main database 50 does not require any indication regarding actual or original content of predetermined fields. In this case, the predetermined fields are customer ID and customer names which are shown in a secondary database 60 in FIG. 4B. While the customer ID and the customer name are replaced or substituted with corresponding keys in the main database 50, it is possible to designate any of remaining fields 52 for substitution. For example, when conditions occur that cause date of last transaction to be critical to security, a field containing the last transaction is assigned a key which replaces ‘Mar. 21, 2006’ date in the main database.

FIG. 4B illustrates content of a secondary database 60 including fields 62 and corresponding data 64. As shown in FIG. 4B, the secondary database 60 holds information without any record being related to another. System generated codes or keys ‘abc’ and ‘xyz’ are stored in association with user generated data ‘123’ and ‘John Smith’ without any relation to each other. Using the illustration of FIG. 1A, the main database 50 may communicatively coupled to the first server 12 and the secondary database 60 to the second server 19.

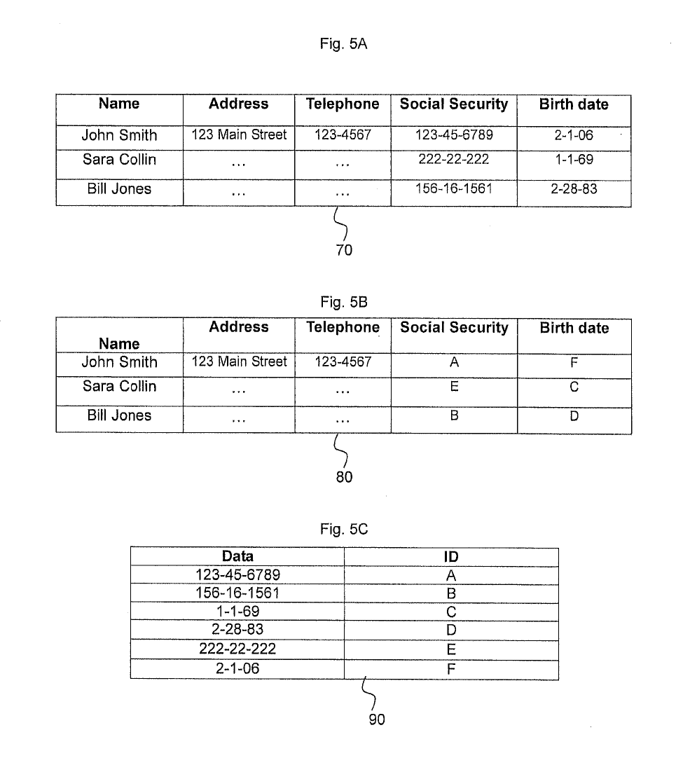

FIG. 5A illustrates content of an original data 70 of a database, FIG. 5B illustrates content resulting from modification 80 to the original data of the database, and FIG. 5C illustrates a record created 90 in accordance with modification to an original data of a database. As illustrated in FIG. 5A, the original data 70 indicates fields and corresponding data while FIG. 5B shows modification to the original data resulting in replacement/substitution of the data with codes randomly assigned to the data. Referring to FIG. 5B, content in the fields containing social security data and birth date are replace with codes A, B, C, D, etc., which are not in any particular order. Each of the data is stored with corresponding codes/keys without any link to the modified 80 data or the original data 70. The original data 70 refers to data prior to application of security measures according to the present invention.

Within each database there are fields without which the data is rendered useless. The system 10 (FIG. 1A) allows such fields to be replaced with generated data (key) without the database or its infrastructure ever being aware of original data or ever being connected to the database. The modification applied to the original data 70 applies a protocol that enables independent storage of data that is crucial to the meaning of the data that ensures security even after the separated data get exposed to unauthorized access.

Various types of environments may be provided as needed including based on a level of security warranted and/or requested by a client. As mentioned above, the databases may be provided at different physical locations, or at a single location with separate access. A type or level of security protocol is provided on demand including based on classification of content in the database and/or business need. A particular database may need as many predetermined fields as the type of data contained in the database.

For a certain type of business, it may be commonly agreed/accepted that particular data needs to be protected while other type of data in the same record does not need to be provided with the same or any other protection. For example, a bank may determine that from a customer record, only the account number and the social security number data needs to be protected while the name of the account holder does not need to be protected. Alternatively, another entity such as the Social Security Administration may consider the social security number field as a critical field where if one removes the social security numbers from the database, the database no longer serves its purpose. In another example of a database consisting of bank transactions, if one were to remove the account holder information such as name, address, telephone number, etc., the bank database would become a laundry list of transactions without serving any particular purpose.

While the fields substituted with a key in FIG. 5B contain numeric data, the present invention is not limited to any a particular format of a field and any field of a record in a database regardless of format may be replaced with a key.

As shown in FIG. 5C, content of the data 90 includes keys and corresponding data without requiring that the content be in any order. Further, data of each predetermined fields are assigned a key or code regardless of format of data originally contained in the fields. In an embodiment, the data 90 may also include an index indicator. The keys and corresponding data 90 have no link to each other. The data 90 includes data from various fields of the original data 70 listed along with corresponding keys of the original data without any link.

FIG. 6 illustrates a process 100 for populating an application with data and providing a record responsive to a request. As shown in FIG. 6, the process 100 begins at operation 101, where a request for information is received. From operation 101, the process 100 moves to operation 103, where a determination is made as to whether the request includes access to data of a predetermined field. For example, a request may be received from client 26 (FIG. 1B) and a determination is made whether data of a predetermined field is requested.

When determining at operation 103 that the request does not include access to data of a predetermined field, the process 100 moves to operation 109 where an application is populated and a complete record of the information is provided in response to the request. For example, the system 20 (FIG. 1B) sends a signal to the application and data server 24 and obtains the requested data.

When determining at operation 103 indicates that the request includes access to data of a predetermined field, the process 100 moves to operation 105, where the data of the predetermined field including a key is pulled from a first database. For example, the system 20 (FIG. 1B) sends a signal to the application and data server 24 and obtains data of the predetermined field including a key.

Subsequent to operation 105, the process 100 moves to operation 107, where another data of the predetermined field is pulled from a second database using the key. For example, the client 26 (FIG. 1B) retrieves a key from the application and data server 24, sends a signal to the server 28 for pulling data using the key.

After operation 107, the process 100 moves to operation 109, where an application is populated and a complete record of the information is provided in response to the request.

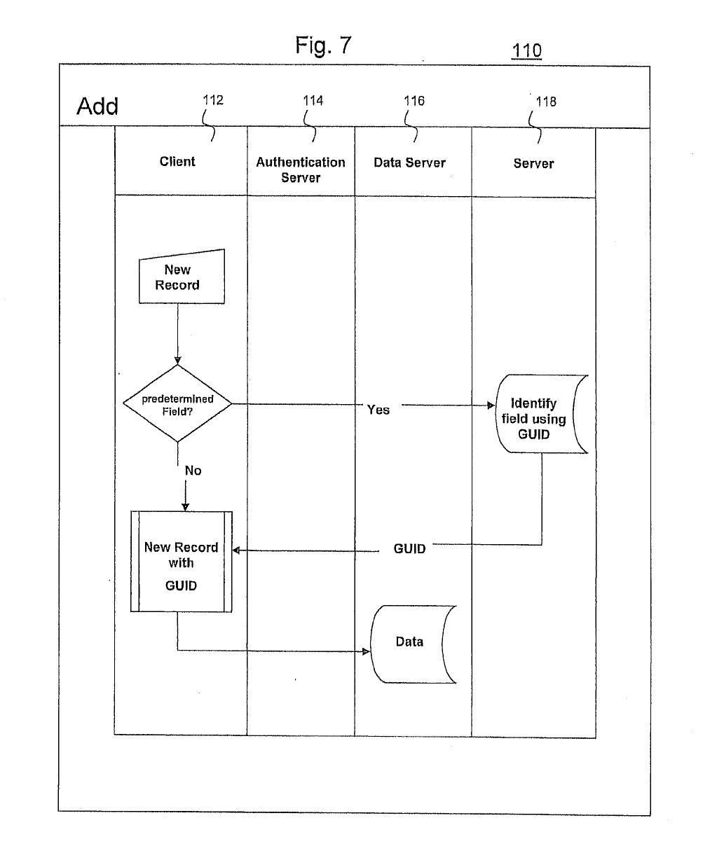

In an embodiment, an operation 110 adds a record as illustrated in FIG. 7. At operation 112, a client adds a new record. It is determined whether the new record contains a predetermined field.

When determining that the new record contains the predetermined field, at operation 118, the server is notified of the field. On the other hand, when determining that the new record does not contain the predetermined field, the operation 110 continues to create the new record with user provided information. As illustrated at operation 110, the data of the new record with a GUID (globally unique identifier) or key is stored in the data server at operation 116. As illustrated in FIG. 7, data of the predetermined field is provided to the server at operation 118 while other data is provided to the data server at operation 116.

In an embodiment, an operation 120 for retrieving data is performed as illustrated in FIG. 8. As shown in FIG. 8, at operation 122, the client reads a request and sends the request for data to the data server at operation 126. The data server at operation 126 provides the data of records retrieved with GUID (key) to the client at operation 122. At operation 122, the client determines that the record contains a predetermined field identified with the GUID and sends a request to the server at operation 128 which provides data corresponding to the GUID.

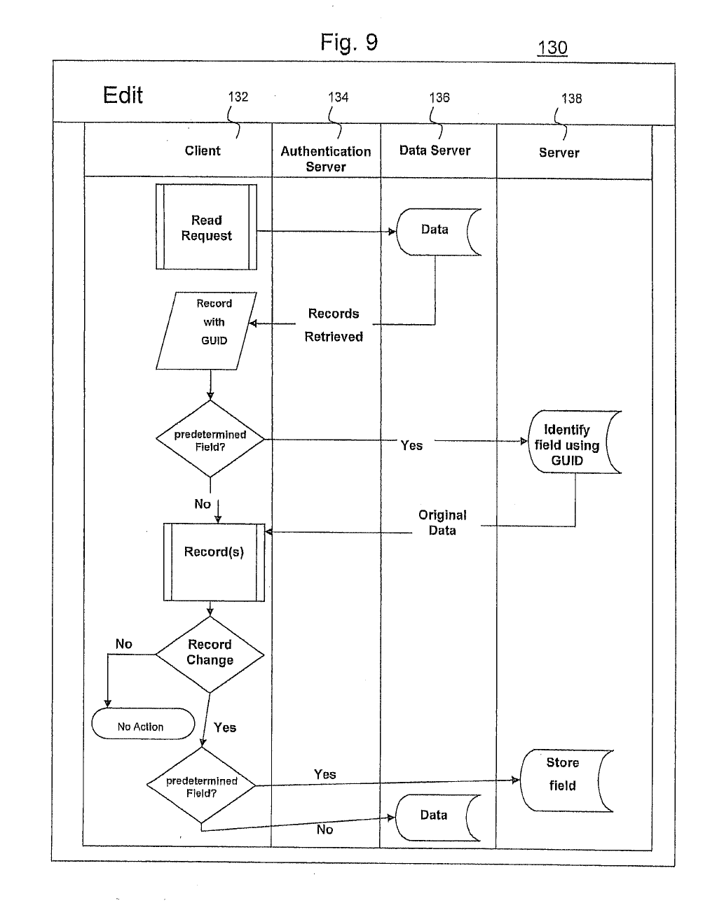

FIG. 9 provides an overview of an operation 130 for editing a record. At operation 132, a client reads a request and submits the request to a data server at operation 136. Referring to FIG. 9, an operation 134 executes authentication of the request and the client via an authentication server. As shown in FIG. 9, at operation 132, the client submits the request subsequent to a user (or request) being verified at operation 134. At operation 136, the data server provides the records retrieved to the client in response to the request. In this case, the records retrieved from the data server contain GUID which causes the client to identify the record as containing a predetermined field and sends a request to the server at operation 138 to obtain data matching the GUID. As shown in FIG. 9, the request sent to the server at operation 138 to the server is independent of the request sent at operation 136 to the data server.

Using the GUID sent from the client with the request at operation 132, the server retrieves corresponding original data and provides the original data as part of the record to the client. When determining that the record retrieved from the data server does not contain a predetermined field, the original data is determined to be provided to the client.

When determining that the client has requested a change to the record, it is determined whether the record contains a predetermined field. When determining that the record to be changed contains the predetermined field, the client accesses the server at operation 138 to cause the change requested. However, when determining that the record to be changed does not contain the predetermined field, the client accesses data server and causes the change to the record to be effected.

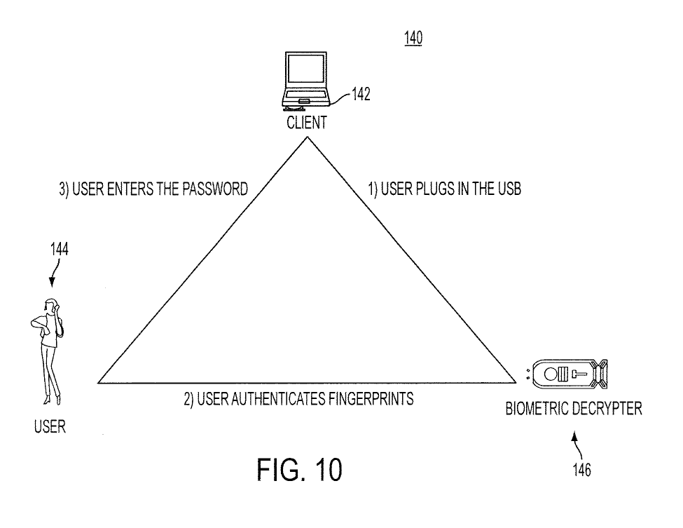

FIG. 10 illustrates a schema 140 for providing a layer of security. As shown in FIG. 10, the schema 140 includes communication between a client 142, user 144 and a biometric decrypter 146. The user plugs in a portable device such as a USB, the user authenticates fingerprints and the user enters a password for authentication. The biometric decrypter 146 may be any device used as part of a login process.

In an embodiment, a user (administrator) stores a token hidden within a directory on the biometric decrypter 146. The application authenticates the token, and only then accepts a user password. The biometric decrypter 146 may be a standard USB device equipped with a fingerprint scanner and/or other information uniquely identifying a user.

The user 144 carries the biometric decrypter 146 and uses it as the user would with any other USB storage device. When the user 144 wants to login, the user plugs in the USB to the client 142, scans fingerprints and enters a password. The password can only be authenticated when the biometric decrypter 146 is present. In an embodiment, the login process can be written in a way that the need for the biometric decrypter 146 can be turned on or off. The on and off mode could be at the application level or the individual user level, as needed.

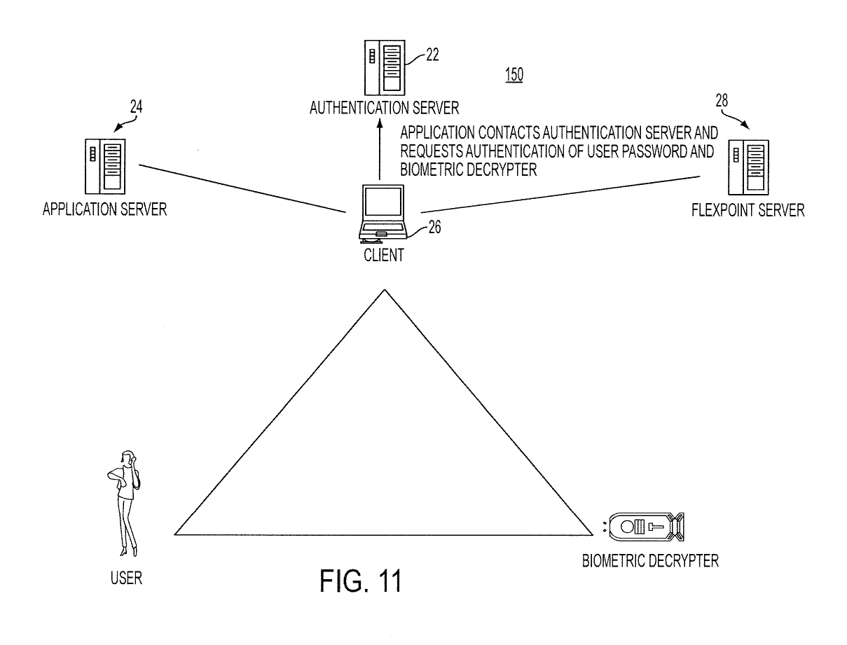

FIG. 11 illustrates a security mechanism 150 for triggering an event when data is compromised. The mechanism 150 involves an application silent alarm (ASA) that triggers an event or a set of events when set off. The alarm may utilize functionality of the biometric decrypter 146 illustrated in FIG. 10. When the biometric decrypter 146 is used, both password and the token get authenticated. Therefore, in order for the ASA to work, an application must be equipped with a biometric decrypter and an event is set off when the user logs in without the biometric decrypter.

When the user logs in without the biometric decrypter, an authentication server authenticates the password and therefore authenticates the user. However, the authentication server also recognizes that the biometric decrypter is not present. The combination of an authenticated password and the absence of the biometric decrypter sets off the ASA. The system can be designed to set off the ASA in which the password is correct and the biometric decrypter is missing. While a particular example of setting the alarm is described, the present invention is not limited to this description. The event may depend on various factors including the nature of the application and perhaps the access level of the user.

The embodiments described herein provide a security protocol which addresses short-comings of typical security technologies and provides a more secure data management. A method and system for translating data of a predetermined field in a record with a key generated to correspond to the data, storing the record with the key in the predetermined field in a first database, and associating the key with the data and storing the association in a second database. A significant value is provided especially due to the vast amount of information becoming available online and the ever increasing need to secure data.

According to an embodiment, one or more fields of a record in any database for which protection is sought are indicated. Determination of which field or fields of a database are indicated may be based on various factor(s) including but not limited to whether the field or fields are critical to ensuring that data is kept safe from unauthorized access. In an embodiment, one or more fields without which the database would be rendered useless would be identified for protection. Data of the predetermined field is substituted (replaced) with other data, a key or code, essentially translating data contained in the predetermined field to the key.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method, comprising:
substituting data of a predetermined field in a record with a key generated to correspond to the data;
storing the record with the key in the predetermined field in a first database; and
associating the key with the data and storing the association in a second database.

2. The method according to claim 1, wherein the key is issued in association with the second database.

3. The method according to claim 1, wherein the first database and the second database do not communicate with each other.

4. The method according to claim 3, wherein the first database and the second database are in physically separate locations from each other.

5. The method according to claim 1, wherein the key is randomly generated.

6. The method according to claim 5, further comprising:
accessing the first database to obtain the generated key in the predetermined field stored in the first database;
accessing the second database to obtain the generated key in association with the corresponding data stored in the second database; and
creating a complete record with said data in the predetermined field in accordance with said accessing of the first database and said accessing of the second database.

7. The method according to claim 6, wherein the complete record is created subsequent to authentication of a user using a biometric decrypter.

8. The method according to claim 7, comprising:
triggering a silent alarm when determining that authentication has failed.

9. The method according to claim 1, comprising:
obtaining the key in the predetermined field from the first database, and
populating the predetermined field with the data by retrieving the data from the second database using the key.

10. The method according to claim 1, wherein the second database contains data items each linked with a corresponding key.

11. The method according to claim 1, comprising:
substituting data of another predetermined field in the record with a corresponding key, and
storing the record having the corresponding key in said another predetermined field in the first database; and
storing the data of said another predetermined field in association with the corresponding key in the second database.

12. The method according to claim 10, wherein the predetermined field and said another predetermined field are of a different format type.

13. The method according to claim 1, wherein the predetermined field is identified for said substituting when the record is created.

14. The method according to claim 1, comprising:
designating each data item entered into the predetermined field to be substituted by a corresponding key.

15. The method according to claim 1, wherein the predetermined field is among a plurality of fields of the record, and
any of the plurality fields are configurable to have corresponding data substituted by a corresponding key.

16. The method according to claim 15, wherein a level of security desired is identified by selecting a candidate number of the plurality of fields for substitution by a corresponding key.

17. A computer-readable medium having stored therein a program for causing a computer to execute operations comprising:
substituting data of a predetermined field in a record with a key generated to correspond to the data;
storing the record with the key in the predetermined field in a first database; and
associating the key with the data and storing the association in a second database.

18. The computer-readable medium according to claim 18, wherein the operations comprise:
building the predetermined field with the data using the key stored in association with the data in the second database.

19. A system, comprising:
a first database storing keys replacing corresponding data of predetermined fields in records;
a second database storing the keys in association with the corresponding data; and
a computer providing the records by retrieving the predetermined fields including keys from the first database, and obtaining the corresponding data associated with the keys from the second database.

20. A method of managing data, comprising:
selecting any field in a record as a candidate field;
storing the record with corresponding data of the candidate field replaced with a key in a first database; and
providing a pointer to the corresponding data of the candidate field in a second database storing the corresponding data in association with the key.
